(19) United States
(12) Patent Application Publication
(10) Pub. No.: US 2012/0130776 A1
(43) Pub. Date: May 24, 2012

(54) TOLL FEE INFORMATION COMMUNICATION SYSTEM, TRAFFIC INFORMATION RECEIVING-ROUTING SYSTEM USING THE TOLL FEE INFORMATION COMMUNICATION SYSTEM AND TRAFFIC INFORMATION RECEIVING METHOD OF THE SAME

(75) Inventor: Kyung Hwan Kang, Seoul (KR)

(73) Assignee: HYUNDAI MOTOR COMPANY, Seoul (KR)

(21) Appl. No.: 13/069,855

(22) Filed: Mar. 23, 2011

(30) Foreign Application Priority Data
Nov. 22, 2010 (KR) 10-2010-0116466

(51) Int. Cl. G07B 15/06; G01C 21/36

(52) U.S. Cl. 705/13

(57) ABSTRACT

A system for receiving traffic information from a toll gate server to provide route guidance to a driver of a vehicle and a method thereof are provided. The traffic information receiving-routing system includes a toll fee information communication system and ah path guide terminal. The toll fee information communication system is configured to communicate with a toll gate server to pay a toll fee when a vehicle approaches to a toll gate, and request traffic information to the toll gate server according to a traffic information request signal to receive the traffic information from the toll gate server. The path guide terminal is configured to generate and transmit the toll fee request signal to the toll fee information communication system when the toll fee information communication system pays a toll fee, receive the traffic information from the toll fee information communication system to guide a path or convey a traffic situation.

### CROSS-REFERENCE TO RELATED APPLICATION

The priority of Korean patent application No. 10-2010-0116466 filed on Nov. 22, 2010, the disclosure of which is hereby incorporated in its entirety by reference, is claimed.

### BACKGROUND OF THE INVENTION

1. Field of the Invention

The present invention relates to a system communicating with a toll gate server to receive traffic information and provide a route guidance path based on the received traffic information and a method thereof.

2. Description of the Related Art

Recently, due to the high volume of traffic and the number of tolls on any given highway, may vehicle drivers have equipped their vehicles with portable toll fee sensors which communicate vehicle and credit card information to an associated server, e.g., a toll gate server, when then vehicle approaches a toll gate to pay a toll fee. However, the current technology does not allow for the toll gate server to communicate information to the vehicle itself which would be beneficial to the drivers, such as the amount of traffic information.

### SUMMARY OF THE INVENTION

The present invention provides a system and method for receiving traffic information from a toll gate server in a vehicle to be used in route guidance of the vehicle.

In one embodiment of the present invention, a toll fee information communication system includes: a first communication module, a toll fee setting module, a second communication module and a control module. The first communication module communicates with a toll gate server when a vehicle approaches a toll gate and the toll fee settling module pays a toll fee to the toll gate server via the first communication module. Additionally, the second communication module then communicates with a path guide terminal and a control module receives traffic information from the toll gate server through the first communication module and provides the received traffic information to the path guide terminal to be used as an aide in providing the driver with the most efficient route guidance path.

Furthermore, in some embodiments of the present invention, the control module receives a traffic information request signal from the path guide terminal and transmits the received traffic information request signal to the toll gate server through the first communication module, and receives the traffic information corresponding to the traffic information request signal from the toll gate server accordingly. The control module receives toll fee payment information from the toll fee settling module and transmits it to the path guide terminal through the second communication module, and receives the traffic information request signal from the path guide terminal according to the toll fee payment information.

In accordance with another aspect of the present invention, a traffic information receiving-routing system includes: a toll fee information communication system and a path guide terminal. The toll fee information system communicates with a toll gate server to pay a toll fee when a vehicle approaches to a toll gate, and requests traffic information from the toll gate server according to a traffic information request signal. The path guide terminal generates and transmits the toll fee request signal to the toll fee information communication system when the toll fee information communication system pays a toll fee, and receives the traffic information from the toll fee information communication system to be utilized in providing the driver is a route or path guidance based on a traffic situation associated with the received traffic information.

In some embodiments of the present invention, the path guide terminal may generate the traffic information request signal upon receiving toll fee payment information from the toll fee information communication system. Additionally, the toll fee information communication system may transmit the toll fee payment information to the path guide terminal after normally paying the toll fee.

Also, the path guide terminal may generate a traffic information request signal requesting traffic information for a road that a vehicle is currently traveling even when a driver does not search a particular travel path/route for that particular road. The path guide terminal may also be configured to generate a traffic information request signal requesting traffic information for a road included in a searched path between a start and a destination when a driver searches the path.

More specifically, the control module is configured to receive the traffic information request signal from the path guide terminal through the second communication module and transmit it to the toll gate server, and receive the traffic information from the toll gate server through the first communication module and provides it to the path guide terminal. The path guide terminal includes according to one embodiment of the present invention includes a data communication module, an electronic map database and path guide module. In particular, the data communication module is configured to receive the traffic information from the toll fee information communication system, and the electronic map database is configured to store an electronic map which is matched with the traffic information by the path guide module to guide a user or driver along a route taking into account traffic situations.

In accordance with another aspect of the present invention, the traffic information receiving-routing system further includes: a voice guide module and a display module. The voice guide module is configured to convey toll fee payment information and a traffic situation to a user with voices, e.g., electronic voices, received by the driver through the speakers of the vehicle. The display module is configured to display an image of an electronic map corresponding to the traffic information received from the gate server.

In accordance with another aspect of the present invention, a traffic information receiving method of a vehicle includes: communicating with a toll gate server to pay a toll fee when the vehicle approaches to a toll gate; requesting and receiving traffic information from the toll gate server; and calculating a route or path based on the received traffic information.

In some embodiments of the present invention, requesting traffic information further includes requesting traffic information for a road that a vehicle is currently traveling to the toll gate server when a driver has not searched for a travel path/route, and requesting traffic information for a road included in a path between a start and a destination searched by a driver when the driver has searched for a path/route.

### BRIEF DESCRIPTION OF THE DRAWINGS

The objects, features and advantages of the present invention will be more apparent from the following detailed description in conjunction with the accompanying drawings, in which:

FIG. 1 is a block diagram illustrating a configuration of a toll fee information communication network according to an exemplary embodiment of the present invention;

FIG. 2 is a block diagram illustrating a configuration of a toll gate server according to an exemplary embodiment of the present invention;

FIG. 3 is a block diagram illustrating a configuration of a toll fee payment device according to an exemplary embodiment of the present invention;

FIG. 4 is a block diagram illustrating a configuration of a path guide terminal according to an exemplary embodiment of the present invention; and

FIG. 5 is a flowchart illustrating an operation of a toll fee information communication network according to an exemplary embodiment of the present invention.

### DETAILED DESCRIPTION OF EXEMPLARY EMBODIMENTS

Exemplary embodiments of the present invention are described with reference to the accompanying drawings in detail. The same reference numbers are used throughout the drawings to refer to the same or like parts. Detailed descriptions of well-known functions and structures incorporated herein may be omitted to avoid obscuring the subject matter of the present invention.

It is understood that the term “vehicle” or “vehicular” or other similar terms as used herein is inclusive of motor vehicles in general such as passenger automobiles including sports utility vehicles (SUV), buses, trucks, various commercial vehicles, watercraft including a variety of boats and ships, aircraft, and the like. The present systems will be particularly useful with a wide variety of motor vehicles.

Generally, the present invention provides a traffic information receiving-routing system which includes a communication system and a path guide terminal. More specifically the communication system is configured to communicate with a toll gate server to pay a toll fee when a vehicle approaches to a toll gate, request traffic information from the toll gate server in response to a traffic information request signal, and receive the requested traffic information at the toll gate. The path guide terminal, on the other hand, is configured to generate and transmit the request signal to the communication system when the communication system pays a toll fee, and receive the traffic information from the communication system. This traffic information is then utilized by the path guide terminal in route guidance and for conveying to a driver one or more traffic situations.

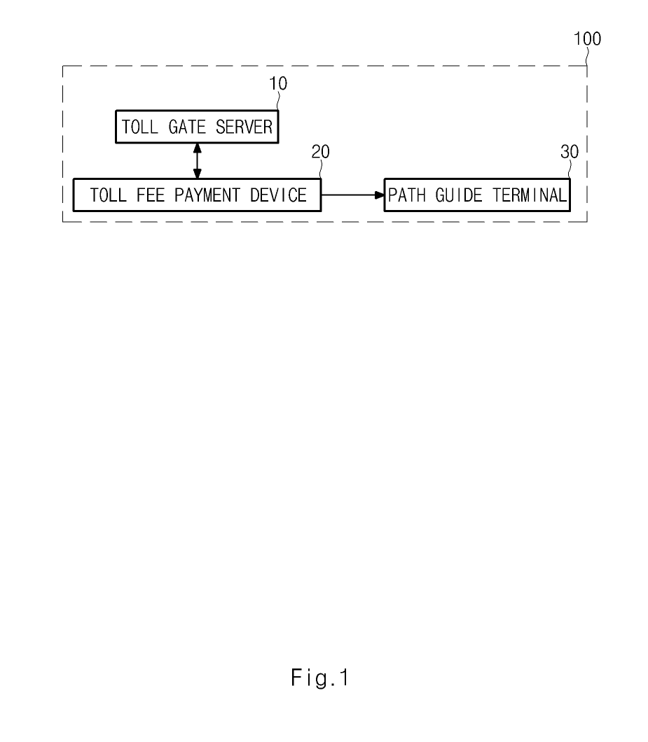

FIG. 1 is a block diagram illustrating a configuration of a toll fee information communication network 100 according to an exemplary embodiment of the present invention.

The toll fee communication network 100 according to an exemplary embodiment of the present invention includes a toll gate server 10, a toll fee payment device 20, and a path guide terminal 30.

The toll server 10 is installed at a toll gate of, e.g., an expressway. When a vehicle enters the toll gate, the toll gate server 10 performs near distance communication with the toll fee payment device 20 mounted/installed in the vehicle to charge a toll fee. Further, when the toll gate server 100 receives a traffic information request signal from the toll fee payment device 20, it provides corresponding traffic information to the toll fee payment device 20. In this case, the toll gate server 10 may provide traffic information to a traffic fee payment device 20 of a vehicle to which a toll fee is normally charged.

The traffic fee payment device 20 is installed/mounted in the vehicle (e.g., within the rearview mirror). When the vehicle passes through the toll gate, the traffic fee payment device 20 communicates with the toll gate server 10 in a wireless scheme to pay the toll fee. In particular, the traffic fee payment device 20 receives traffic information from the toll gate server 10 at the time of paying the toll fee and sends the traffic information to the path guide terminal 30.

The path guide terminal 30 is may be disposed remotely from the toll fee payment device 20 in the vehicle, and provides all types of vehicle information and contents and along with providing route guidance for a vehicle to a driver. In particular, the path guide terminal 30 requests traffic information from the toll gate server 10 through the toll fee payment device 20 and receives the traffic information from the toll gate server 10. Next, the path guide terminal 30 matches the received traffic information to various highways or roads stored on an electronic map to calculate a path/route based on the received traffic situations of a travel road and peripheral roads thereof. In a cases, where route guidance has not been requested by the driver, the path guide terminal may match and store the traffic information on the electronic map and display it accordingly.

By peripheral roads it is meant roads that are connected with a travel road such that the vehicle may bypass said roads.

In the foregoing configuration, the toll fee payment device 20 and the path guide terminal 30 are provided in the vehicle to construct a traffic information receiving-routing system receiving traffic information at the time of paying a toll fee at a toll gate.

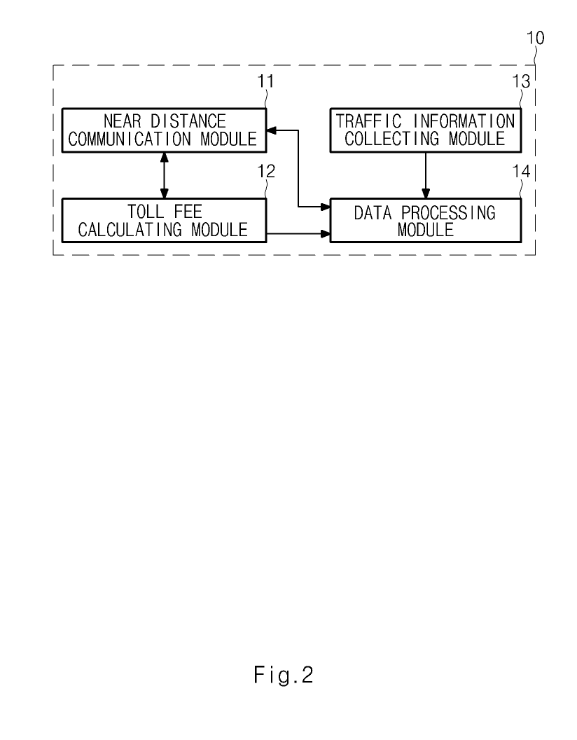

FIG. 2 is a block diagram illustrating a configuration of a toll gate server 10 according to an exemplary embodiment of the present invention.

The toll gate server 10 includes a near distance communication module 11, a toll fee calculating module 12, a traffic information collecting module 13, and a data processing module 14.

The near distance communication module 11 communicates with the toll fee payment device 20 traveling within a predetermined range in a wireless scheme according to a defined communication protocol. The near distance communication module 11 may include a Dedicated Short Range Communications (DSRC) module of, e.g., 5.8 Ghz band, and may be installed at a road side base station of a toll gate for, e.g., an expressway.

The toll fee calculating module 12 communicates with a toll fee payment device 20 of a vehicle entering a toll gate using the near distance communication module 11 to check a travel distance (i.e., the distance traveled on the expressway) and the vehicle type for the entering vehicle. The toll fee calculating module may also be configured to identify a toll fee exemption and reduction target associated with the vehicle. Based on this information, the toll fee calculating module calculates the required toll for the vehicle, sends a toll fee payment request signal to the toll fee payment device 20 and receives a toll fee payment signal as a response thereof. For example, when the toll fee payment device 20 is a prepayment type settlement system, the toll fee payment signal contains charged money amount calculation information of the toll fee payment device 20. Alternatively, when the toll fee payment device 20 is a deferred payment type settlement system, the toll fee payment signal contains settlement information (e.g., credit card information) of the toll fee payment device 20. Further, the toll fee calculating module 12 authorizes passage for a corresponding vehicle according to the toll fee payment signal being received.

The traffic information collecting module 13 communicates with a traffic information provider server (not shown) and receives all types of traffic information from the traffic information provider server. In this case, the traffic information may contain, e.g., traffic communication information (e.g., speed, traffic density, concentration, passing time, expected section average speed, expected section passing time, or the like), traffic command information (command position, command type, command target, command time, or the like), road state information (road surface state, strong rain and snow states), unexpected situation information (unexpected situation position, unexpected situation type, unexpected situation, or the like), and/or weather information (temperature, weather, visible distance, wind speed, wind direction, humidity, atmospheric pressure, or the like).

The data processing module 14 sends traffic information collected from the traffic information collecting module 13 to a toll fee payment device 20 in which fee calculation is normally achieved through the near distance communication module 11. The data processing module 14 may receive a traffic information request signal for a specific path (e.g., a currently traveled path of a entering vehicle or a path requested specifically from a driver) from the toll fee payment device 20. In this case, the data processing module 14 may collect and provide, e.g., only traffic information for a corresponding path to the toll fee payment device 20 using the traffic information collecting module 13.

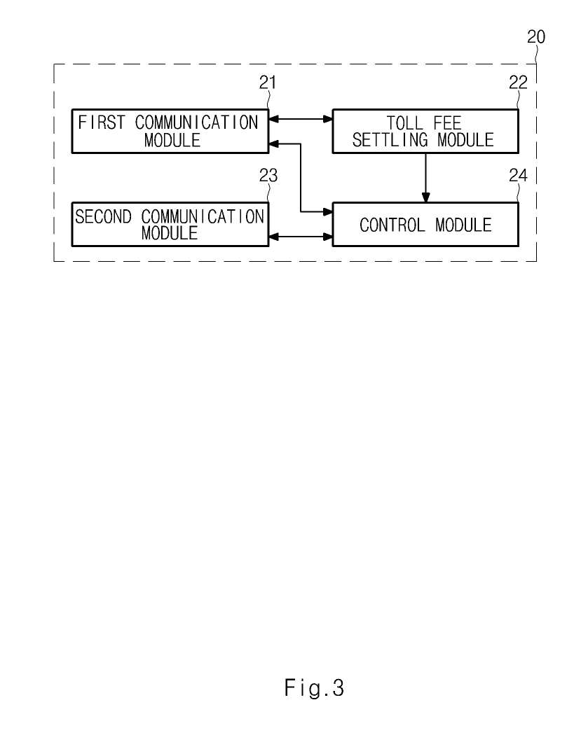

FIG. 3 is a block diagram illustrating a configuration of a toll fee payment device 20 of FIG. 1.

The toll fee payment device 20 includes a first communication module 21, a toll fee settling module 22, a second communication module 23, and a control module 24. The first communication module 21 communicates with a toll gate server 10 according to a defined communication protocol. The first communication module 21 may include a Dedicated Short Range Communications (DSRC) module of, e.g., 5.8 GHz band.

When the toll fee settling module 22 receives a toll fee payment request signal from the toll gate server 10 through the first communication module 21, it generates a toll fee payment signal for paying the toll fee based on a charged toll fee money amount stored in a separate memory and transmits the toll fee payment signal to the toll gate server 10 through the first communication module 21. Further, the toll fee settling module 22 transmits settling information (e.g., credit card information) stored in the toll fee payment device 20 as the toll fee payment signal to the toll gate server 10 through the first communication module 21. Moreover, when a toll fee is paid, the toll fee settling module 22 generates and sends toll fee payment information to the control module 24.

The second communication module 23 communicates with the path guide terminal 300 using a defined communication scheme (e.g., Controller Area Network (CAN)) in the vehicle.

When the control module 24 receives toll fee payment information from the toll fee settling module 22, it sends the received toll fee payment information to the path guide terminal 30. When the control module 24 receives a traffic information request signal for a currently traveled road of a vehicle (e.g., when the vehicle is traveling a specific road without the driver having searched for a travel path/route) or a road between a start and a destination previously searched by a driver (when the vehicle travels a road included in a searched path/route after searching a path) and peripheral roads thereof, it sends the received traffic information request signal to the toll gate server 10 through the first communication module 21. Further, when the control module 24 receives traffic information corresponding to the traffic information request signal (e.g., traffic flow information, traffic control information, road state information, unexpected situation information, and/or weather information for a requested road and peripheral roads thereof) from the toll gate server 10 through the first communication module 21, it sends the received traffic information to the path guide terminal 30. Accordingly, the path guide terminal 30 calculates a path, and/or conveys traffic situations of a currently traveled road and a peripheral situation thereof to a user based on the received traffic information. Moreover, the control module 24 receives toll fee payment information from the toll fee settling module 22 and sends the received toll fee payment information to the path guide terminal 30.

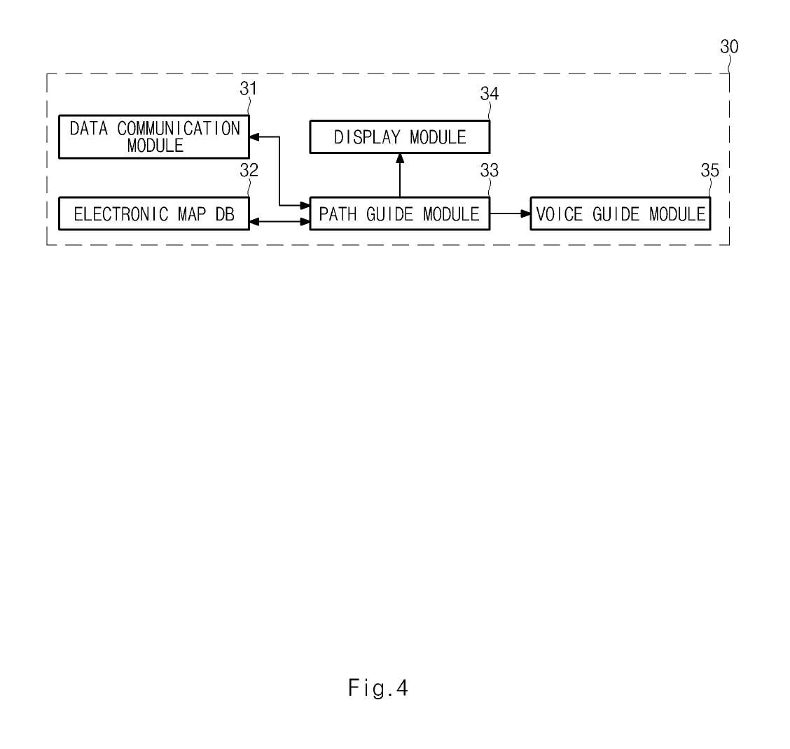

FIG. 4 is a block diagram illustrating a configuration of a path guide terminal 30 of FIG. 1.

The path guide terminal 30 includes a data communication module 31, an electronic map database 32, a path guide module 33, a display module 34, and an voice guide module 35.

When the data communication module 31 receives traffic information from the toll fee payment device 20 through a defined communication scheme (e.g., Controller Area Network (CAN)) in a vehicle, it sends the received traffic information to the path guide module 33. Further, when the data communication 31 receives toll fee payment information from the toll feel payment device 20, it also sends the received toll fee payment information to the path guide module 33.

The electronic map database 32 stores an electronic map containing geographic information and other types of guide related information.

When the path guide module 33 receives toll fee from the toll fee payment device 20, it transmits a traffic information request signal for a road the vehicle is currently traveling on or a road between a start and a destination pre-calculated route which the driver has previously defined and peripheral roads thereof to the toll fee payment device 20 through the data communication module 31, and receives corresponding traffic information from the toll fee payment device 20. When the path guide module 33 receives traffic information from the toll fee payment device 20, it matches the received traffic information with a stored electronic map to calculate a path or convey traffic situations of a travel road and peripheral roads thereof to the user based on the received traffic information. That is, the path guide module 33 may as a result of the received traffic information calculate or recalculate a path/route to be driven by a driver to a bypass the traffic and provide more rapid path based on corresponding traffic information.

Additionally or Alternatively, the path guide module 33 may display a traffic situation (flow situation) by sections of a travel road on an electronic map with different colors according to the traffic situation or display all types of traffic command information, road state information, unexpected situation information, and weather information on the electronic map accordingly. Through this, the path guide terminal 30 may receive traffic information for a path (road) which a vehicle is currently traveling or is being projected to travel at the time of passing through a toll gate, and peripheral roads thereof without a separate traffic information receiver. Accordingly, when traffic congestion of a travel path is heavy, the path guide module 33 may provide and guide the driver via another travel path and display congestion and delay situations of the travel path on a map of a screen.

The display module 34 displays an electronic map to which traffic information is applied on a screen.

The voice guide module guides/conveys toll fee payment information and a traffic situation to the driver via voices through the vehicles speakers/sound system.

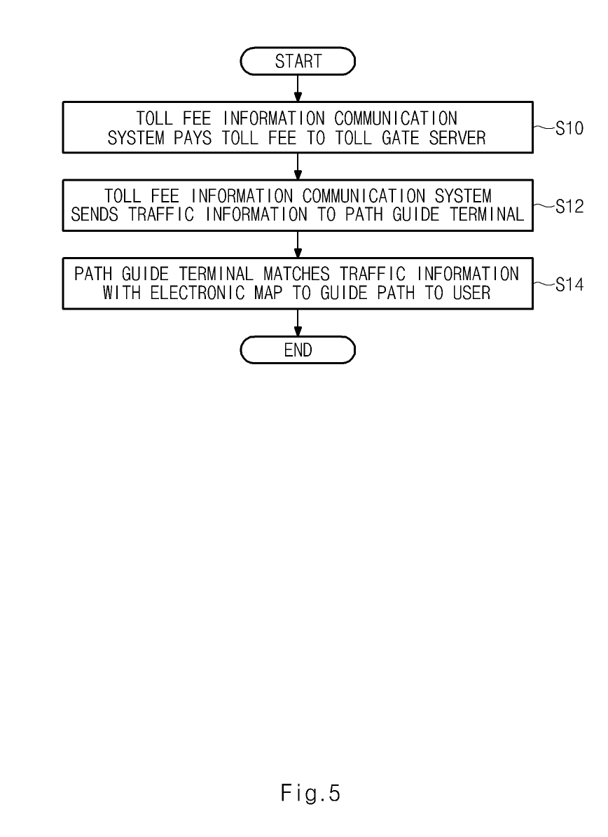

FIG. 5 is a flowchart illustrating an operation of a toll fee information communication network according to an exemplary embodiment of the present invention.

When a vehicle enters a toll gate, a toll gate server 10 transmits a toll fee payment request signal to a toll fee payment device 20. According to the present invention, a toll fee information communication system 10 is mounted/installed in the vehicle. In doing so, a toll fee settling module 22 of the toll fee payment device 20 generates a toll fee payment signal containing charged money remnant (exact calculation) information or settling information and transmits it through a first communication module 21 to a toll gate server 10 to pay a toll fee (S10).

After paying the toll fee, the toll fee payment device 20 transmits toll fee payment information to the path guide terminal 30.

When the path guide terminal 30 receives the toll fee payment information, it transmits a traffic information request signal for a road currently being traveled by the vehicle (e.g., when the vehicle is traveling a specific road without having previously searched for a travel path) or a road between a start and a destination previously searched by a driver (e.g., when the vehicle travels a road included in path searched prior to sending the traffic information request) to the toll fee payment device 20. At this time, the path guide terminal 30 may request traffic information for peripheral roads as well as corresponding road information.

The toll fee payment device 20 then transmits a traffic information request signal received from the path guide terminal 30 to the toll gate server 10.

When the toll gate server 10 receives a traffic information request signal, it transmits traffic information corresponding to the traffic information request signal to the toll fee payment device 20 in via, e.g., a wireless communication scheme. Accordingly, a control module 24 of the toll fee payment device 20 sends the traffic information provided from the toll gate server 10 to the path guide terminal 30 through, e.g., CAN communication (S12).

When a path guide module 33 of the path guide terminal 30 receives the traffic information, it matches the traffic information with an electronic map to guide a path to the user accordingly (S14).

Although exemplary embodiments of the present invention have been described in detail hereinabove, it should be clearly understood that many variations and modifications of the basic inventive concepts herein taught which may appear to those skilled in the present art will still fall within the spirit and scope of the present invention, as defined in the appended claims.

What is claimed is:

1. A toll fee information communication system comprising:
a first communication module communicating with a toll gate server when a vehicle approaches to a toll gate;
a toll fee settling module paying a toll fee to the toll gate server through the first communication module;
a second communication module communicating with a path guide terminal; and
a control module receiving traffic information from the toll gate server through the first communication module and providing the received traffic information to the path guide terminal through the second communication module.

2. The toll fee information communication system of claim 1, wherein the control module receives a traffic information request signal from the path guide terminal, transmits the received traffic information request signal to the toll gate server through the first communication module, and receives the traffic information corresponding to the traffic information request signal from the toll gate server.

3. The toll fee information communication system of claim 1, wherein the control module receives toll fee payment information from the toll fee settling module and transmits the received toll fee payment information to the path guide terminal through the second communication module, and receives the traffic information request signal from the path guide terminal according to the toll fee payment information.

4. A traffic information receiving-routing system, comprising:
a toll fee information communication system communicating with a toll gate server to pay a toll fee when a vehicle approaches to a toll gate, and requesting traffic information from the toll gate server according to a traffic information request signal to receive the traffic information from the toll gate server; and
a path guide terminal generating and transmitting the toll fee request signal to the toll fee information communication system when the toll fee information communication system pays a toll fee, and receiving the traffic information from the toll fee information communication system to guide a path or convey a traffic situation.

5. The traffic information receiving-routing system of claim 4, wherein the path guide terminal generates the traffic information request signal upon receiving toll fee payment information from the toll fee information communication system.

6. The traffic information receiving-routing system of claim 5, wherein the toll fee information communication system transmits the toll fee payment information to the path guide terminal after paying the toll fee.

7. The traffic information receiving-routing system of claim 5, wherein the path guide terminal generates a traffic information request signal requesting traffic information for a road that the vehicle is currently traveling when a driver has not previously searched a travel path.

8. The traffic information receiving-routing system of claim 5, wherein the path guide terminal generates a traffic information request signal requesting traffic information for a road included in a searched path between a start and a destination when a driver has searched the path.

9. The traffic information receiving-routing system of claim 4, wherein the toll fee information communication system comprises:
a first communication module communicating a toll gate server when a vehicle approaches to a toll gate;
a toll fee settling module paying a toll fee to the toll gate server through the first communication module;
a second communication module communicating with a path guide terminal; and
a control module receiving the traffic information request signal from the path guide terminal through the second communication module and transmitting the traffic information request signal to the toll gate server, and receiving the traffic information from the toll gate server through the first communication module and providing the received traffic information to the path guide terminal.

10. The traffic information receiving-routing system of claim 4, wherein the path guide terminal comprises:
a data communication module receiving the traffic information from the toll fee information communication system;
an electronic map database storing an electronic map; and
a path guide module matching the traffic information with the electronic map to guide a path or convey a traffic situation to a user.

11. The traffic information receiving-routing system of claim 10, further comprising:
a voice guide module guiding toll fee payment information and a traffic situation to a user with voices; and
a display module displaying an image of an electronic map corresponding to the traffic information.

12. A traffic information receiving method for a vehicle, comprising:
communicating, via a toll fee paying device, with a toll gate server to pay a toll fee when the vehicle approaches to a toll gate;
requesting, by the toll fee paying device, traffic information to the toll gate server to receive the traffic information from the toll gate server; and
guiding a path and conveying a traffic situation, via a path guide terminal using the traffic information.

13. The method of claim 12, wherein requesting traffic information further comprises requesting traffic information for a road the vehicle is currently traveling on to the toll gate server when a driver has not previously searched for a travel path.

14. The method of claim 12, wherein requesting traffic information further comprises requesting traffic information for a road included in a path between a start and a destination searched for by a driver.

15. A traffic information receiving-routing system, comprising:
a communication system configured to communicate with a toll gate server to pay a toll fee when a vehicle approaches to a toll gate, request traffic information from the toll gate server in response to a traffic information request signal, and receive the requested traffic information at the toll gate; and
a path guide terminal configured to generate and transmit the request signal to the communication system when the communication system pays a toll fee, and receive the traffic information from the communication system, the traffic information utilized by the path guide terminal in route guidance and for conveying to a driver one or more traffic situations.
